(19) United States
(12) Patent Application Publication
(10) Pub. No.: US 2025/0103914 A1
(43) Pub. Date: Mar. 27, 2025

(54) SYSTEMS AND METHODS FOR REGULARIZING MACHINE LEARNING MODELS WITH SYNTHETIC OUTLIERS

(71) Applicant: JPMORGAN CHASE BANK, N.A., New York, NY (US)

(72) Inventors: Wei-Cheng HUANG, New York, NY (US); Richard CHEN, Baldwin Place, NY (US); Hsiang HSU, Boston, MA (US)

(21) Appl. No.: 18/475,758

(22) Filed: Sep. 27, 2023

(51) Int. Cl. G06N 5/022

(52) U.S. Cl. CPC G06N 5/022

(57) ABSTRACT

In some aspects, the techniques described herein relate to a method including: determining a first cross-entropy loss, wherein the first cross-entropy loss is determined based on a set of predictions, and wherein the set of predictions are based on a classifier head of a machine learning model generating the set of predictions based on a set of feature vectors; updating the classifier head and a prompt of the machine learning model with the first cross-entropy loss; generating outlier samples based on the set of feature vectors; providing, as input to the classifier head, the set of feature vectors and the outlier samples, wherein a second cross-entropy loss and an outlier regularization loss are computed by the classifier head based on the set of feature vectors and the outlier samples; and updating the classifier head with the second cross-entropy loss and the outlier regularization loss.

### BACKGROUND

### 1. Field of the Invention

Aspects generally relate to systems and methods for regularizing machine learning models with synthetic outliers.

### 2. Description of the Related Art

Given the dynamic nature of the real world and the rate of data collection, after deployment, a model requires periodic updates to incorporate knowledge from new observations (i.e., to be trained on new data). But it is inefficient and, in some cases, impractical to re-train a model from scratch on a combined set of new (i.e., unseen data) data and old (i.e., already-learned) data at every model update. Moreover, simply tuning a model with new data causes catastrophic forgetting of old data, and model performance with respect to the old data may collapse. For a model to be trained on new data, while, at the same time, maintaining as much knowledge and performance as possible with respect to old data, and at much lower costs than re-training from the ground up, is the goal of continual learning techniques.

It had been shown that by using large pre-trained machine learning (ML) models along with learnable prompts, good performance may be achieved in a rehearsal-free class-incremental learning (CIL) setting. To prevent knowledge from newer training sessions from overwriting that of older training sessions, however, these models often require a pool of prompts where prompts included in the pool are associated with different training sessions. This scenario makes extra computation for a query vector necessary in order to compose an appropriate prompt from the pool.

### SUMMARY

In some aspects, the techniques described herein relate to a method including: determining a first cross-entropy loss, wherein the first cross-entropy loss is determined based on a set of predictions, and wherein the set of predictions are based on a classifier head of a machine learning model generating the set of predictions based on a set of feature vectors; updating the classifier head and a prompt of the machine learning model with the first cross-entropy loss; generating outlier samples based on the set of feature vectors; providing, as input to the classifier head, the set of feature vectors and the outlier samples, wherein a second cross-entropy loss and an outlier regularization loss are computed by the classifier head based on the set of feature vectors and the outlier samples; and updating the classifier head with the second cross-entropy loss and the outlier regularization loss.

In some aspects, the techniques described herein relate to a method, wherein the prompt is fixed after updating the classifier head and the prompt of the machine learning model with the first cross-entropy loss.

In some aspects, the techniques described herein relate to a method, wherein Huber loss is a component in computing the outlier regularization loss.

In some aspects, the techniques described herein relate to a method, wherein generating the outlier samples includes applying Gaussian noise to samples at a boundary of a cluster, wherein the cluster is formed by samples from a same training session.

In some aspects, the techniques described herein relate to a method, wherein outlier generation is performed in a feature vector space [symbol] ^{D}.

In some aspects, the techniques described herein relate to a method, wherein the machine learning model includes a pre-trained encoder.

In some aspects, the techniques described herein relate to a system including at least one computer including a processor and a memory, wherein the at least one computer is configured to: determine a first cross-entropy loss, wherein the first cross-entropy loss is determined based on a set of predictions, and wherein the set of predictions are based on a classifier head of a machine learning model generating the set of predictions based on a set of feature vectors; update the classifier head and a prompt of the machine learning model with the first cross-entropy loss; generate outlier samples based on the set of feature vectors; provide, as input to the classifier head, the set of feature vectors and the outlier samples, wherein a second cross-entropy loss and an outlier regularization loss are computed by the classifier head based on the set of feature vectors and the outlier samples; and update the classifier head with the second cross-entropy loss and the outlier regularization loss.

In some aspects, the techniques described herein relate to a system, wherein the prompt is fixed after updating the classifier head and the prompt of the machine learning model with the first cross-entropy loss.

In some aspects, the techniques described herein relate to a system, wherein Huber loss is a component in computing the outlier regularization loss.

In some aspects, the techniques described herein relate to a system, wherein generation of the outlier samples includes the at least one computer being configured to apply Gaussian noise to samples at a boundary of a cluster, wherein the cluster is formed by samples from a same training session.

In some aspects, the techniques described herein relate to a system, wherein outlier generation is performed in a feature vector space [symbol] ^{D}.

In some aspects, the techniques described herein relate to a system, wherein the machine learning model includes a pre-trained encoder.

In some aspects, the techniques described herein relate to a non-transitory computer readable storage medium, including instructions stored thereon, which instructions, when read and executed by one or more computer processors, cause the one or more computer processors to perform steps including: determining a first cross-entropy loss, wherein the first cross-entropy loss is determined based on a set of predictions, and wherein the set of predictions are based on a classifier head of a machine learning model generating the set of predictions based on a set of feature vectors; updating the classifier head and a prompt of the machine learning model with the first cross-entropy loss; generating outlier samples based on the set of feature vectors; providing, as input to the classifier head, the set of feature vectors and the outlier samples, wherein a second cross-entropy loss and an outlier regularization loss are computed by the classifier head based on the set of feature vectors and the outlier samples; and updating the classifier head with the second cross-entropy loss and the outlier regularization loss.

In some aspects, the techniques described herein relate to a non-transitory computer readable storage medium, wherein the prompt is fixed after updating the classifier head and the prompt of the machine learning model with the first cross-entropy loss.

In some aspects, the techniques described herein relate to a non-transitory computer readable storage medium, wherein Huber loss is a component in computing the outlier regularization loss.

In some aspects, the techniques described herein relate to a non-transitory computer readable storage medium, wherein generating the outlier samples includes applying Gaussian noise to samples at a boundary of a cluster, wherein the cluster is formed by samples from a same training session.

In some aspects, the techniques described herein relate to a non-transitory computer readable storage medium, wherein outlier generation is performed in a feature vector space [symbol] ^{D}.

In some aspects, the techniques described herein relate to a non-transitory computer readable storage medium, wherein the machine learning model includes a pre-trained encoder.

### BRIEF DESCRIPTION OF THE DRAWINGS

FIG. 1a is a block diagram of a system for regularizing classifier models with synthetic outliers, in accordance with aspects.

FIG. 1b is a block diagram of a system for regularizing classifier models with synthetic outliers, in accordance with aspects.

FIG. 1c is a block diagram of a system for regularizing classifier models with synthetic outliers, in accordance with aspects.

FIG. 2 is a logical flow for regularizing classifier models with synthetic outliers, in accordance with aspects.

FIG. 3 is a block diagram of a technology infrastructure and computing device for implementing certain aspects of the present disclosure, in accordance with aspects.

### DETAILED DESCRIPTION

Aspects generally relate to systems and methods for regularizing machine learning models with synthetic outliers.

Continual learning with respect to machine learning models may be framed as training a model with a sequence of training sessions. As used herein, a training session is a process for updating a machine learning model using a new dataset that the model has not previously been updated with. A training session updates a model to a new version of the model that considers patterns learned from exposure to the new dataset during the training.

One challenging aspect of continual learning includes a setting of class-incremental learning (CIL), in which an entire dataset is split into multiple training sessions, but at inference the session to which the input belongs is unknown to the model. This extra constraint introduces the need for the model to distinguish inputs from different training sessions. A typical approach to this scenario is termed “rehearsal.” Rehearsal includes storing a subset of old data (i.e., a historic dataset) to fine-tune the model along with appropriate new data. However, in many real-world cases, the required historic data may not be available due to storage limits or privacy concerns. Meanwhile, rehearsal-free methods have often lagged behind their rehearsal-based counterpart routines.

It may be demonstrated, however, that results comparable, or even superior to, results from rehearsal-based trainings can be achieved in CIL classification training sessions by employing large pre-trained models and techniques known as parameter-efficient fine-tuning (PEFT). Such techniques include having a majority of parameters of a pre-trained model frozen (i.e., fixed) while finetuning a small subset of parameters. Using PEFT, catastrophic model forgetting may be greatly ameliorated.

In accordance with aspects, under a heuristic of separately storing data for different training sessions, so as to prevent interference between them, a pool of prompts may be used, which pool may include subsets of the pool. Each subset of the pool may correspond to a different training session. A prompt to be inserted into the model may be generated from the pool, conditioning on a query vector, which query vector, itself, may in turn be an encoding of the input produced by the model. This approach, however, may present issues.

With respect to the noted issues, firstly, the above approach may require passing through the model twice per input, one time for the query vector, and another time with the composed prompt for classification. That is, an input may be encoded twice, first by the encoder alone to produce the query, then the query may be used to produce the prompt from the pool. Then, the input may be encoded the second time, but this time with the prompt inserted into the encoder in order to modify the second encoding. This new (second) encoding is then used in classification. This double encoding, however, doubles the running cost of a modeling operation.

Secondly, because an assignment by the model of classes to training sessions is random, it has no semantic meaning. Accordingly, desired training session-specific prompts that are found based on an input without having a separate model to identify the correct training session may likely be inaccurate. As further discussed herein, however, discarding the prompt pool and the prompt-composing mechanism and using a single prompt (referred to herein as a “one-pass” procedure) to be updated by all training sessions, does not necessarily negatively affect model accuracy, and may generate savings in computational costs.

Aspects include regularization techniques based on synthetic outlier samples to address the issues noted, above. Using the disclosed regularization techniques, a decision boundary for each class that may be predicted by a classifier model may be more precisely delineated, thereby reducing the chance of model confusion with classes belonging to (i.e., generated from) other training sessions.

In accordance with aspects, the parts of a classification head (also referred to herein as a classifier head) that correspond to each training session may be trained independently. Conventional CIL techniques reduce recency bias and may cause a classifier to output high scores for inputs it has not seen, thereby leading to inaccurate classification predictions. By generating synthetic outliers around training data, however, the region that the classifier associates with a particular class may be narrowed with high confidence, such that inputs from other training sessions can avoid being classified incorrectly.

In accordance with aspects, in the CIL setting of classification, a model may be trained on N training sessions sequentially. Each training session may include a set of classes that does not overlap with classes included in other training sessions. A training and test dataset for each training session may be expressed as [symbol] ₜᵣₐᵢₙⁱ, [symbol] ₜₑₛₜⁱ, i∈{1, . . . , N}. Further, Tᵢ may denote the set of classes that belongs to training session i, such that if class cⱼ∈Tᵢ, then cⱼ∉T_{i′}∀i′∈{1, . . . , N}\i. Generally, the total J classes {c₁, . . . , c_{J})} are evenly distributed among N training sessions and the classes may be reordered such that the classes belonging to the same training session are contiguous:

$${T}_{i} = \{ {C}_{\frac{J}{N} \times i + 1} , … , {C}_{\frac{J}{N} \times ( i + 1 )} \} \qquad ∀ i ∈ \{ 1 , … , N \} .$$

In accordance with aspects, a typical classifier model includes an encoder and a classification head where the encoder may be denoted by θ, and the classification head by ϕ. Then, for a given input x, the encoder projects the input into the feature space [symbol] ^{D}. The classification head may then produce prediction scores corresponding to all classes, and the class with the highest score becomes the prediction:

$$f = θ ( x ) ∈ {ℝ}^{D}$$

$$v = ϕ ( f ) ∈ {ℝ}^{J}$$

$$\hat{y} = {{argmax v}_{j}}_{j ∈ \{ 1 , … , J \}}$$

Superscripts may be used to denote versions of the models after each training session, such that a randomly initialized model before training is characterized as (θ°, ϕ⁰), and (θⁱ, ϕⁱ) represents the model after training/updating (θⁱ⁻¹, ϕⁱ⁻¹) with training session i data. [symbol] may denote the training algorithm (e.g., Stochastic Gradient Descent (SGD)) that is used to train the model, such that given model ϑ, training data [symbol] , and training loss [symbol] , training will produce the updated model ϑ′, where ϑ′= [symbol] (ϑ, [symbol] , [symbol] ). Further, with typical cross-entropy loss [symbol] _{CE}, a training process in CIL may be formulated as:

$$( {θ}^{i} , {ϕ}^{i} ) = ( ( {θ}^{i - 1} , ( {ϕ}^{i - 1} ) , {\hat{𝒟}}_{train}^{i} , {ℒ}_{CE} ) .$$

In accordance with aspects, in a rehearsal-free environment, [symbol] ₜᵣₐᵢₙⁱ= [symbol] ₜᵣₐᵢₙⁱ (i.e., only new data is used during the update). This is as opposed to rehearsal-based methods, where [symbol] ₜᵣₐᵢₙⁱ may be any subset of the union of all data previously encountered/learned by the model, which may be characterized as:

[symbol]

ₜᵣₐᵢₙⁱ⊂∪ⱼ₌₁ⁱ [symbol] ₜᵣₐᵢₙ^{j}

In accordance with aspects, a fixed pre-trained encoder may be specified as θ, a classification head may be ϕ, and a prompt pool containing pairs of prompts and keys may be expressed as [symbol] ={(k₁, P₁), . . . , (k_{M}, P_{M})}. Accordingly, a feature vector of input x produced by the encoder θ alone may be expressed as θ(x)∈ [symbol] ^{D}, and a feature vector of input x produced by the encoder θ based on prompt p as input may be expressed as θₚ(x)∈ [symbol] ^{D}.

For prompt-based models, only the prompts [symbol] and the classification head ϕ may be updated, and the encoder θ may stay unchanged throughout the process. Additionally, in practice the classification head ϕ may be decomposed into N parts, where each part outputs scores for classes that belongs to a particular training session. These parts may be denoted by underscripts, such that ϕ= {ϕ₁, . . . , ϕ_{N}}. Each ϕ₁ may only be trained on training session i in order to avoid recency bias. Accordingly, for any given training session i, ϕ_{i′}ⁱ=ϕ_{i′}ⁱ⁻¹ for all i′≠i. Thus, in the context of prompt-based, rehearsal-free CIL, the training process noted above may be formulated as:

$$( θ , ( {ϕ}^{i} , {𝒫}^{i} ) = ( ( θ , {ϕ}^{i - 1} , {𝒫}^{i - 1} ) , {𝒟}_{train}^{i} , {ℒ}_{CE} )$$

where

$${ϕ}_{i}^{i} , = {ϕ}_{i}^{i - 1} ∀ {i}^{′} ∈ \{ 1 , … , N \} ∖ i .$$

In the above process, only [symbol] and ϕⁱ may be updated, where θ and the remaining parts of ϕ may not be updated. Further, to produce predictions, the outputs of all parts of the classifier head ϕ may be concatenated:

$$v = ϕ ( {θ}_{p} ( x ) ) = [ ( {ϕ}_{1} ( {θ}_{p} ( x ) ) ; … ; {ϕ}_{N} ( {θ}_{p} ( x ) ) ]$$

$$where$$

$${ϕ}_{i} ( \cdot ) ∈ {ℝ}^{J / N} .$$

Therefore, conventional prompt-based methods follow the process steps:

$$p = ℱ ( θ ( x ) , 𝒫 ) ,$$

$$v = ϕ ( {θ}_{p} ( x ) ) ,$$

$$\hat{y} = {argmax}_{j ∈ \{ 1 , … , J \}} {v}_{j} ,$$

where [symbol] composes the prompt based on the query and the prompt pool, and each existing work has its own definition of [symbol] . In comparison, a one-pass procedure may have its p given and may not execute the first step (i.e., p= [symbol] (θ(x), [symbol] )). In some aspects, a one-pass procedure may be viewed as having its own [symbol] produce the p regardless of input x.

In accordance with aspects, CIL may be decomposed into two subproblems: within-session prediction (WP) and session-ID prediction (TP). Essentially, WP is to differentiate classes from the same training session, and TP is to identify the correct training session given the input. Thus, to obtain better CIL performance, at least one of these subproblems should be addressed while not degrading performance with respect to the other. In exemplary aspects, given a fixed, pre-trained model, a one-pass procedure may retain good WP performance. Moreover, TP may be solved without an explicit training session classifier, and a regularization method based on synthetic outliers may be used to enhance TP.

With respect to a one-pass procedure, a threat to WP performance is the continuously updated prompt, such that after tuning the prompt on new data, the feature vectors of old data computed with the new prompt may drift. In theory, too much drift may cause the WP accuracy on previous training sessions to drop significantly. Experimental results, however, have suggested otherwise-namely that WP accuracy does not fall considerably as more training sessions are encountered and, in fact, may result in most training sessions actually being improved with respect to accuracy.

Consequently, the remaining source for a drop in accuracy in CIL environments is the confusion between training sessions. A reason for this phenomenon is that data from different training sessions never appear together during training, so the classifier has not learned to produce low scores for classes in other training sessions. Hence, there is need for a procedure to “shrink” the region in the feature space where the classifier produces high scores for the current training session.

In accordance with aspects, and as eluded to above, a model may include three parts: a fixed, pre-trained encoder, a classification head (i.e., the head), and a prompt pool. The classification process of an input may be as follows: the encoder may calculate a vector representative of the input, then the classification head may calculate the vector's scores with respect to all classes. The prompt may include a set of vectors that is outputted by an algorithm based on the prompt pool and the input. Each existing prompt-based method may have its own algorithm for composing the prompt. The prompt may be inserted into the encoder to modify how the encoder encodes the input. Accordingly, among the three components, the encoder may remain fixed throughout a training process, and both the prompt pool and the head may be updated in each training session.

In accordance with aspects, regularization may be employed by adding an extra phase in model training, such that in the first phase the prompts [symbol] and the classification head ϕ will be tuned using the usual cross-entropy loss, and in the second phase only the classification head ϕ will be updated using the combination of cross-entropy loss and the described regularization loss.

In an exemplary training process, for each training session and its own set of data, three steps may be performed to update a model. A first step may include training a model with cross-entropy loss. A second step may include fixing (i.e., freezing) a prompt and computing all feature vectors of inputs of the current training session. The feature vectors may be used to generate outlier sample vectors. A third step may include updating a classifier head ϕ of the model being trained with both the cross-entropy loss from the first step and the regularization loss from the second step.

In accordance with aspects, by not updating prompt [symbol] the regularization may not affect the feature extractor, as a whole, thereby reducing feature drift. Specifically, for each training session i after the first training step, a set [symbol] _{Out}ⁱ of synthetic outliers may be generated based on a training set [symbol] ₜᵣₐᵢₙⁱ. After generation of [symbol] _{Out}ⁱ, the classifier head ϕᵢ may be trained on both [symbol] ₜᵣₐᵢₙⁱ and [symbol] _{Out}ⁱ, with the combination of cross-entropy loss and an additional regularization term:

$$ℒ = {ℒ}_{CE} + λ {ℒ}_{Out}$$

$${ℒ}_{Out} = ℋ ( ReLU ( {E}_{In} ( x , i ) - {τ}_{In} ) ) + ℋ ( ReLU ( {τ}_{Out} - {E}_{Out} ( z , i ) ) )$$

$${E}_{In} ( x , i ) = - log {\sum }_{x ∈ {𝒟}_{train}^{i}} {e}^{{ϕ}_{i} ( {θ}_{p} ( x ) )}$$

$${E}_{Out} ( z , i ) = - log {\sum }_{z ∈ {𝒟}_{Out}^{i}} {e}^{{ϕ}_{i} ( z )}$$

with i∈{1, . . . , N} being the training session identifier and λ, τ_{In}, and τ_{Out} being scalar hyperparameters, and [symbol] being either squared error or Huber loss against zero.

In accordance with aspects, given all samples in the training set, the samples at the boundary of the cluster are first identified. Then, a Gaussian noise may be applied to the identified samples to form outliers. Notably the outlier generation process may be done in the feature vector space [symbol] ^{D}, based on the feature vectors of those inputs in the training set.

In accordance with aspects, the generated outliers may be used to regularize the classifier head ϕ directly, as opposed to training separate outlier detectors as in conventional outlier synthesis. This is advantageous because in CIL environments, all training sessions are separate and thus training separate outlier detectors would require one detector for each training session. In this scenario, it may be difficult to design an appropriate way to choose the correct training session for each detector, since all of the detectors are trained locally on each individual training session. By not having separate detectors, the need for introducing and searching for a sufficient set of respective hyperparameters is eliminated.

In accordance with aspects, an implementing organization may provide a pre-trained encoder θ, an initialized prompt pool [symbol] ⁰, and a classifier head ϕ⁰ in a modeling engine configured for class-incremental learning. The modeling engine may be configured with, or with access to, a training dataset [symbol] ₜᵣₐᵢₙ, a learning or training algorithm [symbol] , a loss functions [symbol] _{CE} and [symbol] _{Out}, outlier generator [symbol] , scalar λ, and prompt-composing function [symbol] .

In accordance with aspects, a modeling engine may execute a procedure or algorithm for prompt-based CIL with synthetic outlier regularization, where for each training session i∈{1, . . . , N}, the following computations may be executed:

(θ,φ, [symbol] ⁱ)← [symbol] ((θ,ϕⁱ⁻¹, [symbol] ⁱ⁻¹), [symbol] ₜᵣₐᵢₙⁱ, [symbol] _{CE})

[symbol]

_{Out}ⁱ←{ [symbol] (θₚ(x))|x∈ [symbol] ₜᵣₐᵢₙⁱ,p= [symbol] (θ(x), [symbol] ⁱ)}

(θ,ϕⁱ, [symbol] ⁱ)← [symbol] ((θ,φ, [symbol] ⁱ),( [symbol] ₜᵣₐᵢₙⁱ, [symbol] _{Out}ⁱ), [symbol] _{CE}+λ [symbol] _{Out})

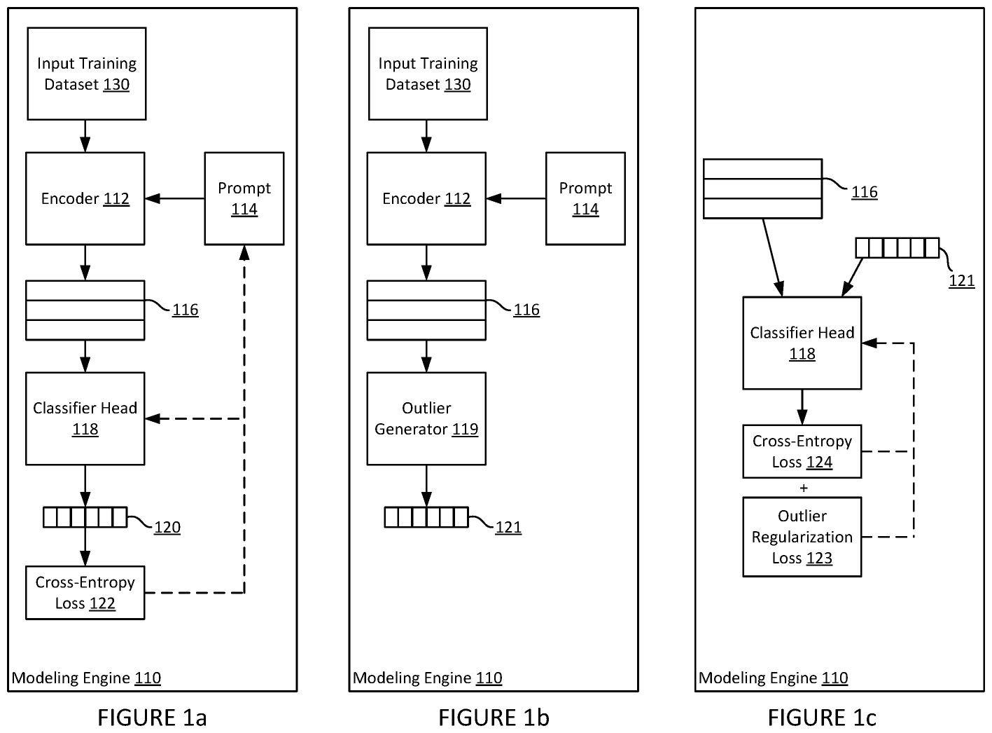

FIG. 1a is a block diagram of a system for regularizing classifier models with synthetic outliers, in accordance with aspects. FIG. 1a includes modeling engine 110, which includes encoder 112, prompt 114, feature vectors 116, classifier head 118, classification predictions 120, cross-entropy loss 122, and input training data set 130. FIG. 1a depicts a training procedure that updates classifier head 118 and prompt 114 with cross-entropy loss 122. Input training dataset 130 may be used as input data to encoder 112. Encoder 112 encodes feature vectors 116 based on input training dataset 130. Classifier head 118 generates classification predictions 120 based on feature vectors 116. Cross-entropy loss 122 may be generated from classifier head 118's output of classification predictions 120. Cross-entropy loss 122 may then be used to update prompt 114 and classifier head 118.

FIG. 1b is a block diagram of a system for regularizing classifier models with synthetic outliers, in accordance with aspects. In FIG. 1b, prompt 114 is fixed (i.e., not updated), and outlier generator 119 generates outlier samples 121 from the computed feature vectors 116. Outlier samples 121 may be an additional set of feature vectors.

FIG. 1c is a block diagram of a system for regularizing classifier models with synthetic outliers, in accordance with aspects. In FIG. 1c, feature vectors 116 and outlier samples 121 are used as input to classifier head 118 and the resultant cross-entropy loss 124 and outlier regularization loss 123 are used to update classifier head 118.

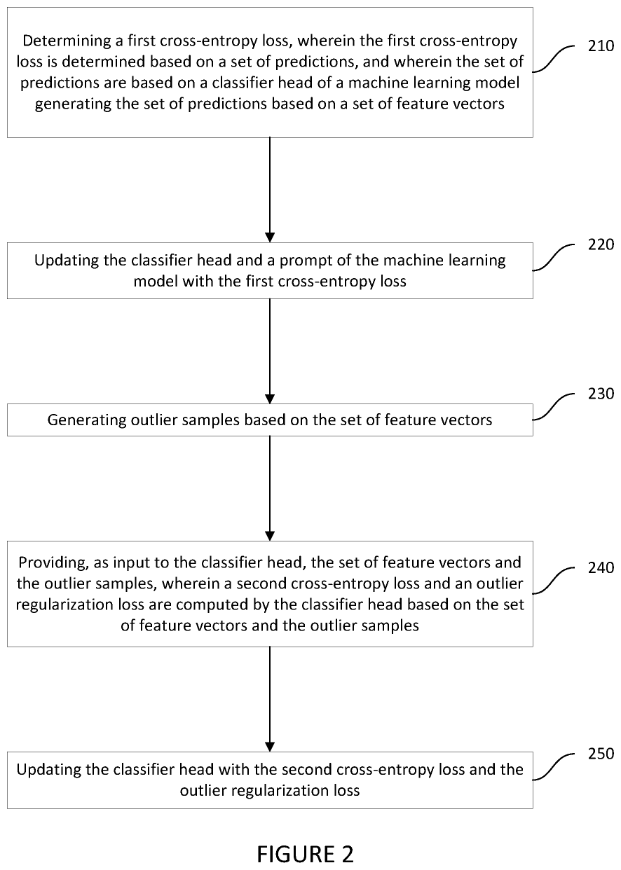

FIG. 2 is a logical flow for regularizing classifier models with synthetic outliers, in accordance with aspects.

Step 210 includes determining a first cross-entropy loss, wherein the first cross-entropy loss is determined based on a set of predictions, and wherein the set of predictions are based on a classifier head of a machine learning model generating the set of predictions based on a set of feature vectors.

Step 220 includes updating the classifier head and a prompt of the machine learning model with the first cross-entropy loss.

Step 230 includes generating outlier samples based on the set of feature vectors.

Step 240 includes providing, as input to the classifier head, the set of feature vectors and the outlier samples, wherein a second cross-entropy loss and an outlier regularization loss are computed by the classifier head based on the set of feature vectors and the outlier samples.

Step 250 includes updating the classifier head with the second cross-entropy loss and the outlier regularization loss.

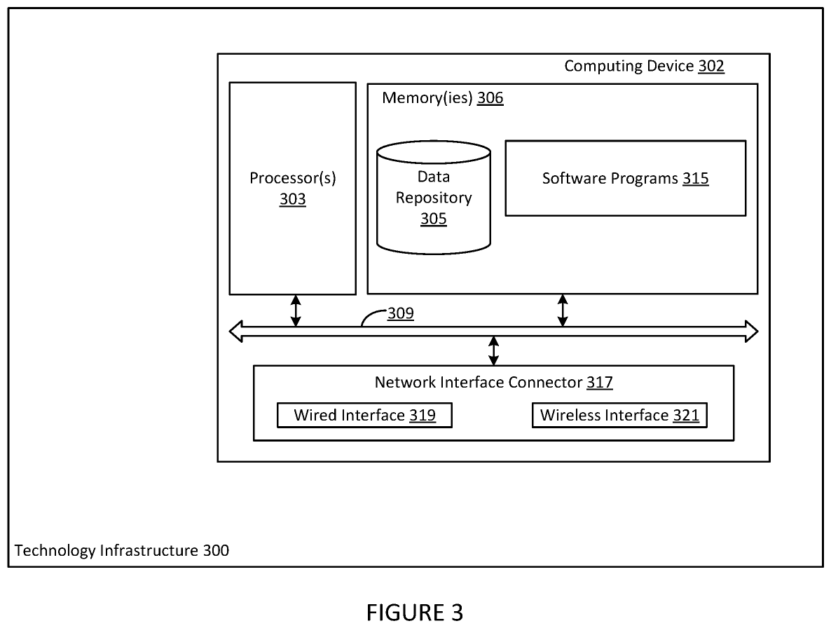

FIG. 3 is a block diagram of a technology infrastructure and computing device for implementing certain aspects of the present disclosure, in accordance with aspects. FIG. 3 includes technology infrastructure 300. Technology infrastructure 300 represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with aspects, system components such as a modeling engine, an encoder, a classifier head, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, training session, or training sessions, such as those steps/training sessions described above, including any logical steps or logical flows described above. Such a set of instructions for performing a particular training session may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
determining a first cross-entropy loss, wherein the first cross-entropy loss is determined based on a set of predictions, and wherein the set of predictions are based on a classifier head of a machine learning model generating the set of predictions based on a set of feature vectors;
updating the classifier head and a prompt of the machine learning model with the first cross-entropy loss;
generating outlier samples based on the set of feature vectors;
providing, as input to the classifier head, the set of feature vectors and the outlier samples, wherein a second cross-entropy loss and an outlier regularization loss are computed by the classifier head based on the set of feature vectors and the outlier samples; and
updating the classifier head with the second cross-entropy loss and the outlier regularization loss.

2. The method of claim 1, wherein the prompt of the machine learning model is fixed after updating the classifier head and the prompt of the machine learning model with the first cross-entropy loss.

3. The method of claim 1, wherein Huber loss is a component in computing the outlier regularization loss.

4. The method of claim 1, wherein generating the outlier samples includes applying Gaussian noise to samples at a boundary of a cluster, wherein the cluster is formed by samples from a same training session.

5. The method of claim 1, wherein the outlier sample generation is performed in a feature vector space [symbol] ^{D}.

6. The method of claim 1, wherein the machine learning model includes a pre-trained encoder.

7. A system comprising at least one computer including a processor and a memory, wherein the at least one computer is configured to:
determine a first cross-entropy loss, wherein the first cross-entropy loss is determined based on a set of predictions, and wherein the set of predictions are based on a classifier head of a machine learning model generating the set of predictions based on a set of feature vectors;
update the classifier head and a prompt of the machine learning model with the first cross-entropy loss;
generate outlier samples based on the set of feature vectors;
provide, as input to the classifier head, the set of feature vectors and the outlier samples, wherein a second cross-entropy loss and an outlier regularization loss are computed by the classifier head based on the set of feature vectors and the outlier samples; and
update the classifier head with the second cross-entropy loss and the outlier regularization loss.

8. The system of claim 7, wherein the prompt of the machine learning model is fixed after updating the classifier head and the prompt of the machine learning model with the first cross-entropy loss.

9. The system of claim 7, wherein Huber loss is a component in computing the outlier regularization loss.

10. The system of claim 7, wherein generation of the outlier samples includes the at least one computer being configured to apply Gaussian noise to samples at a boundary of a cluster, wherein the cluster is formed by samples from a same training session.

11. The system of claim 7, wherein the outlier sample generation is performed in a feature vector space [symbol] ^{D}.

12. The system of claim 7, wherein the machine learning model includes a pre-trained encoder.

13. A non-transitory computer readable storage medium, including instructions stored thereon, which instructions, when read and executed by one or more computer processors, cause the one or more computer processors to perform steps comprising:
determining a first cross-entropy loss, wherein the first cross-entropy loss is determined based on a set of predictions, and wherein the set of predictions are based on a classifier head of a machine learning model generating the set of predictions based on a set of feature vectors;
updating the classifier head and a prompt of the machine learning model with the first cross-entropy loss;
generating outlier samples based on the set of feature vectors;
providing, as input to the classifier head, the set of feature vectors and the outlier samples, wherein a second cross-entropy loss and an outlier regularization loss are computed by the classifier head based on the set of feature vectors and the outlier samples; and
updating the classifier head with the second cross-entropy loss and the outlier regularization loss.

14. The non-transitory computer readable storage medium of claim 13, wherein the prompt of the machine learning model is fixed after updating the classifier head and the prompt of the machine learning model with the first cross-entropy loss.

15. The non-transitory computer readable storage medium of claim 13, wherein Huber loss is a component in computing the outlier regularization loss.

16. The non-transitory computer readable storage medium of claim 13, wherein generating the outlier samples includes applying Gaussian noise to samples at a boundary of a cluster, wherein the cluster is formed by samples from a same training session.

17. The non-transitory computer readable storage medium of claim 13, wherein the outlier sample generation is performed in a feature vector space [symbol] ^{D}.

18. The non-transitory computer readable storage medium of claim 13, wherein the machine learning model includes a pre-trained encoder.
